(19) United States
(12) Patent Application Publication
(10) Pub. No.: US 2017/0078225 A1
(43) Pub. Date: Mar. 16, 2017

(54) CONTENT INFERENCE ENGINE BASED ON USER BEHAVIOR

(71) Applicant: Verizon Patent and Licensing Inc., Arlington, VA (US)

(72) Inventors: Gyanesh Pandey, San Jose, CA (US); Devin Blong, Penngrove, CA (US); Paresh Vakhariya, Cupertino, CA (US); Kevin Flores, San Jose, CA (US); I-Han Chen, Fremont, CA (US)

(21) Appl. No.: 14/855,554

(22) Filed: Sep. 16, 2015

(51) Int. Cl. H04L 12/58; H04L 12/24; G06Q 30/02; H04L 29/08

(52) U.S. Cl. CPC H04L 51/046; H04L 67/306; H04L 41/22; H04L 67/02; G06Q 30/0269; G06Q 30/0277

(57) ABSTRACT

Techniques described herein may be used to analyze written messages between users (e.g., messages in a mobile messaging application, simple messaging service (SMS) messages, instant messages, etc.) to identify media content being discussed by the users. Additionally, the opinions of the users regarding the media content (e.g., favorable, unfavorable, etc.) may be deciphered and used to update user profiles. The updated user profiles may be used to provide media content recommendations for the users, targeted marketing to the users, rating scores for the media content, and user reviews for the media content. The analysis of the written message may also enable the written messages to be organized (e.g., according to topic) within a graphic user interface (GUI) of each user device.

### BACKGROUND

User devices (e.g., smartphones, tablet computers, laptop computers, etc.) may enable users to communicate with one another via written messages. For instance, a user may communicate with other users via Short Messaging Service (SMS), an instant messaging service, by posting message on a webpage forum, etc. The messages sent between users may be displayed to each user in a graphical user interface (GUI) of a user device. A sequence of messages between the users may amount to a discussion regarding one or more topics, which may include comments and opinions relating to music, images, videos, television shows, movies, and other types of media content.

### BRIEF DESCRIPTION OF THE DRAWINGS

Embodiments of the present disclosure will be readily understood by the following detailed description in conjunction with the accompanying drawings. To facilitate this description, like reference numerals may designate like structural elements. Embodiments of the disclosure are illustrated by way of example and not by way of limitation in the figures of the accompanying drawings.

FIG. 1 is an example overview of an implementation described herein;

FIG. 2 is a diagram of an example environment in which systems and/or methods described herein may be implemented;

FIG. 3 is a flowchart diagram of an example process for utilizing written messages communicated between users as described herein;

FIG. 4 is a logical flow diagram of an example for organizing written messages, creating user profile information, and generating user reviews as described herein;

FIG. 5 is an example of written messages that have been organized with a graphical user interface (GUI) of user device;

FIG. 6 is a logical flow diagram of an example for utilizing user profile information that is generated from written messages between users;

FIG. 7 is a diagram of an example for creating media content reviews based on written messages from users; and

FIG. 8 is a diagram of example components of a device.

### DETAILED DESCRIPTION OF PREFERRED EMBODIMENTS

The following detailed description refers to the accompanying drawings. The same reference numbers in different drawings may identify the same or similar elements. It is to be understood that other embodiments may be utilized and structural or logical changes may be made without departing from the scope of the present disclosure. Therefore, the following detailed description is not to be taken in a limiting sense, and the scope of embodiments in accordance with the present invention is defined by the appended claims and their equivalents.

Techniques described herein may be used to analyze written messages, that relate to or otherwise discuss media content (e.g., music, images, videos, etc.), for commentary and opinions about the media content. The information relating to the commentary and opinions may in turn be used to thematically organize the written messages with a graphical user interface (GUI), improve media content recommendations, provide target advertising, rate media content, and generate user reviews for media content.

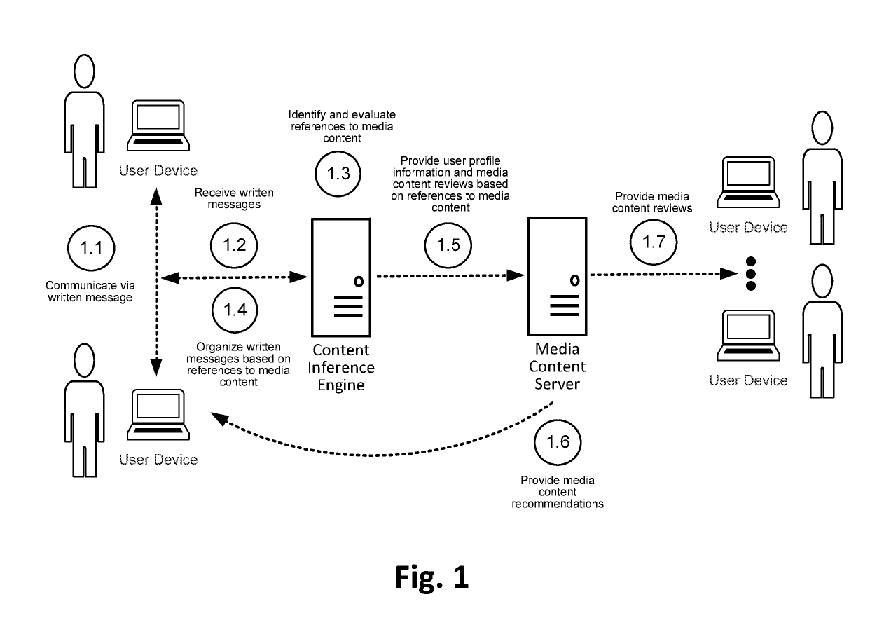

FIG. 1 illustrates an example overview of an implementation described herein. As shown, users may operate user devices to communicate with one another via written messages, which may include messages transmitted via an SMS service, an instant messaging service, etc. (at 1.1). A content inference engine may receive a copy of the written messages (at 1.2). The content inference engine may analyze the written messages do identify whether any of the written messages include references to media content and evaluate the nature of the references (e.g., what media content is being referenced, whether the user liked or disliked the media content, etc.) (at 1.3). The content inference engine may communicate with the user devices in order to organize how the written messages are displayed to the users (at 1.4). For instance, the content inference engine may cause the user devices to display a descriptive title above a series of messages that discuss a particular movie or video.

The content inference engine may also provide a media content server with user profile information and media content reviews that are based on the references to the media content (at 1.5). For instance, if the references to the media content indicate that users enjoyed a particular movie, the content inference engine may generate user profile information that indicates the preference of the users for the particular movie. Additionally, the content inference engine may communicate the users' references to the media content to rate the media content or quote the users' references in order to provide user reviews of the media content.

The media content server may use the new user profile information to provide media content recommendations to the users (at 1.6). In some implementations, the user profile information may also be used to provide target advertising to the users. Additionally, the media content server may provide the media content reviews to other users that may be interested in viewing the media content referenced by the users (at 1.7). As such, techniques described herein may be used to thematically organize written messages between users, improve media content recommendations, provide target advertising, rate media content, and generate user reviews for media content.

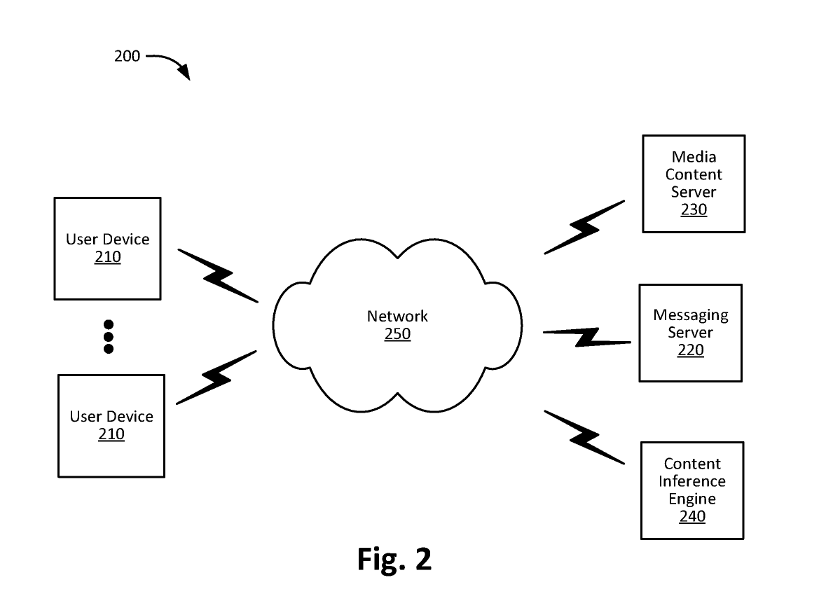

FIG. 2 is a diagram of an example environment 200 in which systems and/or methods described herein may be implemented. Environment 200 may include user devices 210, messaging server 220, media content server 230, content inference engine 240, and network 250. As shown, messaging server 220, content server 230, and content inference engine 240 may be implemented as separate devices; however, in some implementations, two or more of messaging server 220, content server 230, and content inference engine 240 may be implemented by a single device.

User device 210 may include a portable computing and communication device, such as a personal digital assistant (PDA), a smart phone, a cellular phone, a laptop computer with connectivity to a cellular wireless network, a tablet computer, etc. User device 210 may also include a non-portable computing device, such as a desktop computer, a consumer or business appliance, or another device that has the ability to connect to network 240. In some implementations, user device 210 may include a set top box, a video game console, or a similar device, capable of communicating with messaging server 220, content server 230, and/or content inference engine 240 via network 240.

Messaging server 220 may include one or more computing devices, such as a server device or a collection of server devices, capable of enabling user devices 210 to communicate with one another via a messaging service. In some implementations, messaging server 220 may be an application server for a mobile application installed on user device 210. The mobile application may enable user devices 210 to view media content from media content serer 230 and exchange written message between one another. Additionally, the messaging service supported by messaging server 220 may include an SMS messaging service, an instant messaging service, a website forum, or another type of messaging service that enables user devices to communicate via written messages. In some implementations, messaging server 220 may provide the written messages communicated between user devices 210 to content inference engine 240 so that the messages may be used by content inference engine 240 as described herein.

Media content server 230 may include one or more computing devices, such as a server device or a collection of server devices, associated with a content provider that may provide media content to user devices 210. In some implementations, content server 260 may be a web server that hosts webpages and/or content (e.g., images, videos, audio, etc.). Additionally, or alternatively, a link to content stored by media content server 230 may be presented within an application or webpage associated with a web server or application server. In some implementations, media content server 230 may provide user device 210 with media content reviews and/or media content recommendations based on user profile information, which may include demographic information, a viewing history, viewing preferences, and other information relevant to recommending media content to a user of user device 210.

Content inference engine 240 may include one or more computing devices, such as a server device or a collection of server devices, capable of performing one or more of the operations described herein. For example, content inference engine 240 may receive a copy of the written messages communicated between user devices 210, analyze the written messages to determine whether any of the messages include references to media content, and determine the substance of the references (e.g., what media content is being referenced, the opinion of the user regarding the media content (e.g., whether the user liked or disliked the media content), etc.). Additionally, content inference engine 240 may communicate with user devices 210 in order to organize how the written messages are displayed to the users in a GUI. Content inference engine 240 may also provide media content server 230 with user profile information and media content reviews that are based on the references to the media content in the written messages.

Network 250 may include one or more wired and/or wireless networks. For example, network 250 may include a cellular network (e.g., a second generation (2G) network, a third generation (3G) network, a fourth generation (4G) network, a fifth generation (5G) network, a long-term evolution (“LTE”) network, a global system for mobile (“GSM”) network, a code division multiple access (CDMA) network, an evolution-data optimized (EVDO) network, or the like), a public land mobile network (PLMN), and/or another network. Additionally, or alternatively, network 250 may include a local area network (LAN), a wireless LAN (WLAN), a wide area network (WAN), a metropolitan network (MAN), the Public Switched Telephone Network (PSTN), an ad hoc network, a managed IP network, a virtual private network (VPN), an intranet, the Internet, a fiber optic-based network, and/or a combination of these or other types of networks.

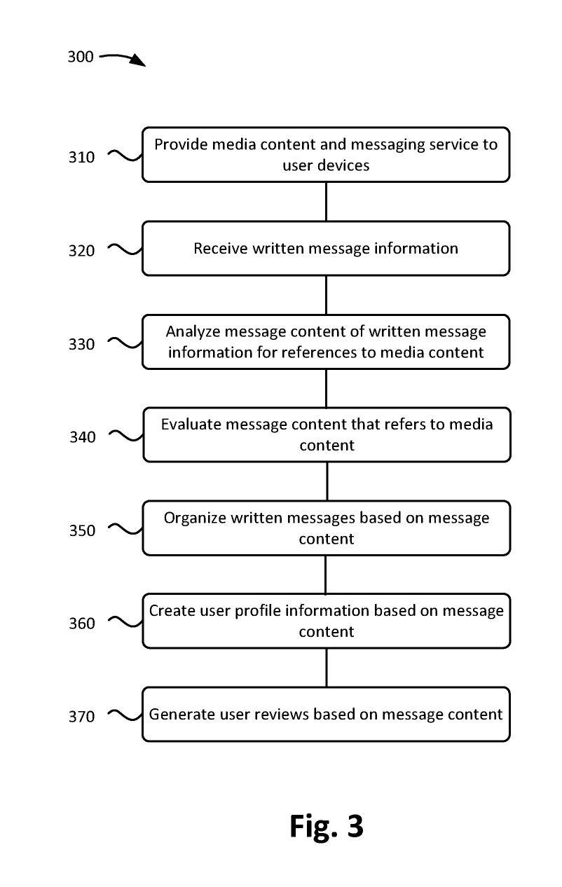

FIG. 3 is a flowchart diagram of an example process 300 for utilizing written messages communicated between users as described herein. In some implementations, process 300 may be implemented by content inference engine 240. In some implementations, process 300 may be implemented by one or more of messaging server 220, media content server 230, and content inference engine 240.

As shown, process 300 may include providing media content and a messaging service to user devices 210 (block 310). For example, messaging server 220 may be an application server for a mobile application that enables user devices 210 to view media content from media content serer 230 and exchange written message between one another. The instant messaging service may provide functionality for sharing (e.g., by posting hyperlinks) media content between users. The media content may be supported by media content server 230. In some implementations, the media content and/or the messaging service may be provided by content inference engine 240.

Process 300 may also include receiving a written message and/or information about the written message (block 320). For instance, content inference engine 240 may receive a copy of a message that is being communicated between user devices 210. Additionally, content inference engine 240 may receive information identifying the user device 210 sending the message, information identifying a user of the user device 210 sending the message, and timing information (e.g., a timestamp) corresponding to when the written message was sent.

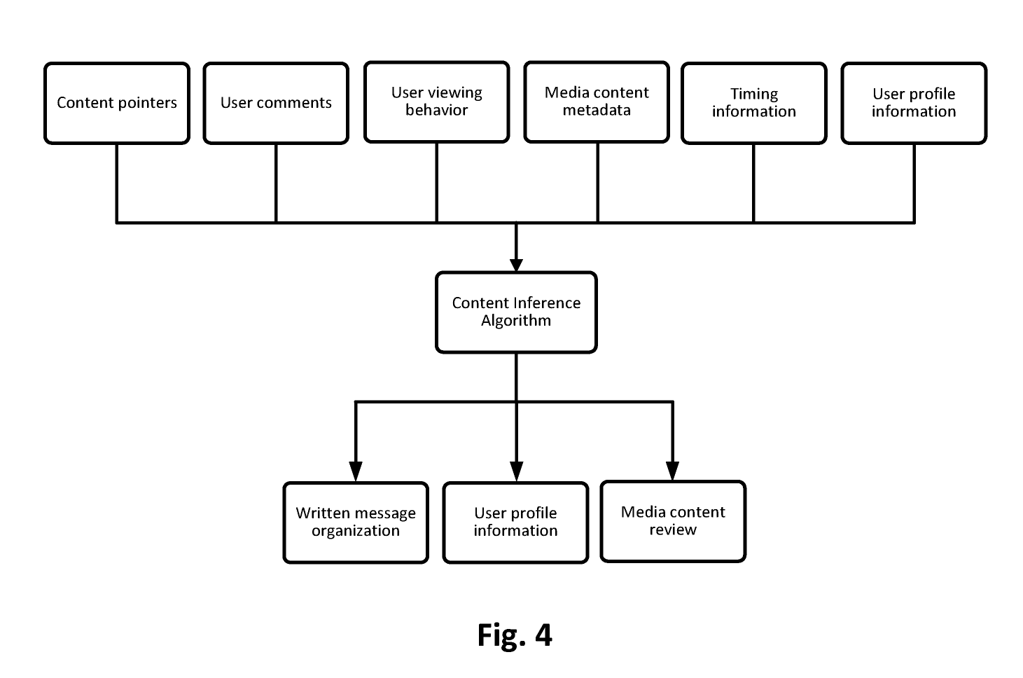

Process 300 may include analyzing the message content of the written message for references to media content (block 330). For example, content inference engine 240 may inspect a written message to determine whether the written message references an image, music, a video, etc. Message content may include the information within the message itself, such as words and phrases typed out by a user of the user device 210 sending the message. In some implementations, a written message may directly reference media content by, for example, including a hyperlink to an image or a video. In some implementations, a written message may indirectly reference media content by, for example, including a comment that refers to media content included in a recently transmitted message. FIG. 4, and the corresponding description below, provides an example of identifying written messages that reference media content.

Process 300 may include evaluating message content that refers to media content (block 340). For instance, content inference engine 240 may determine the nature of the content in a written message. The message content may include words or phrases typed out by a user, emoticons, images, hyperlinks to media content, descriptions of media content, etc. In some implementations, content inference engine 240 may evaluate message content by determining whether or not a user enjoyed the corresponding media content and how much (or how little) the user enjoyed the media content.

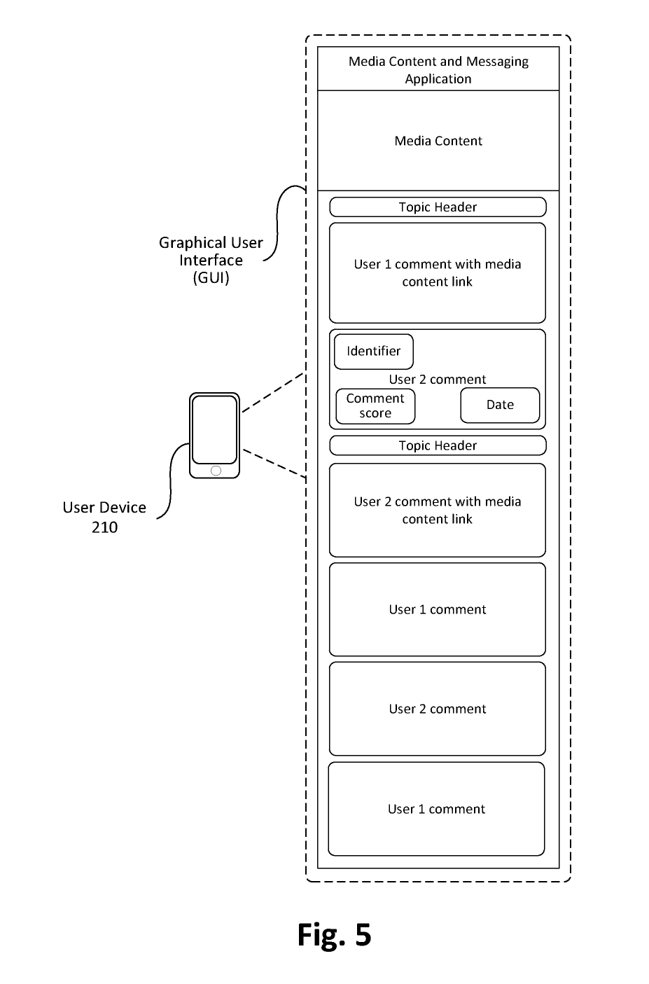

Process 300 may include organizing written messages based on the message content (block 350). For example, content inference engine 240 may cause user devices 210 to organize written messages displayed within a GUI of user devices 210 based on the message content of the written messages. In some implementations, content inference engine 240 may cause user devices 210 to organize written message by causing user devices 210 to insert titles within the GUI to indicate when a particular piece of media content is being discussed. FIG. 5, and the corresponding description, provides an example of organizing written messages based on message content.

Process 300 may include creating user profile information based on the message content (block 360). For instance, content inference engine 240 may generate user profile information for a particular user based on written messages from the user. For instance, when a written message indicates that a user appears to have enjoyed a particular movie, content inference engine 240 may create user profile information indicating a preference by the user for the movie (e.g., the opinion of the user regarding the movie), a category of movies, movies by the same or similar directors, movies with similar themes or actors, etc. As another example, when a written message indicates that the user appears to have not enjoyed a movie, content inference engine 240 may create user profile information indicating the user's lack of a preference for the movie, a category of movies, movies by the same or similar directors, movies with similar themes or actors, etc. In some implementations, content inference engine 240 may communicate the user profile information to another network device, such as media content server 230, so that media content recommendations provided to the user may take into account whether or not (and/or how much) the user enjoyed a particular piece of media content.

Process 300 may include generating user reviews based on message content (block 370). For instance, content inference engine 240 may create a user review based on written message from the user. In some implementations, a user review may include an actual quote copied from a written message from the user regarding the media content. In some implementations, a user review may include a rating (e.g., thumbs-up, a number of stars, etc.) that is indicative of the user's preference for the corresponding media content. In some implementations, a user review may include demographic information (or other types of user profile information) that may be used to identify whether another user might also enjoy the media content.

FIG. 4 is a logical flow diagram of an example for organizing written messages, creating user profile information, and generating user reviews. In some implementations, logical flow diagram may be implemented by content inference engine 240.

As shown, content inference engine 240 may use several types of information to perform the operations described herein. Examples of such information may include content pointers, user comments, user viewing behavior, media content metadata, timing information, and user profile information. In some implementations, additional information, alternative information, or less information may be used by content inference engine 240 to organize written messages, create user profile information, generate user reviews, and more.

Content pointers may include a representation of media content (e.g., a hyperlink, a selectable image combined with a hyperlink, etc.) that is communicated from one user device 210 to another user device 210. The content pointer may appear in a discussion that includes a sequence of written messages sent between user devices 210. In some implementations, a user that receives a content pointer to from another user may select the content pointer in order to view the media content, whether it be an image, music, a video, etc.

Selecting the content pointer may cause user device 210 to receive the corresponding media content from media content server 230. In some implementations, the content pointer may direct user device 210 to an entire piece of media content (e.g., an entire movie) or a sub-section of the media content (e.g., a particular scene from a movie (which may be indicated by a timestamp associated within the movie)). In some implementations, identifying content pointers may help enable content inference engine to identify written messages that refer to media content since written messages that, for example, immediately precede or follow a content pointer is likely to refer to the media content associated with the content pointer.

User viewing behavior may include information corresponding to the viewing history of a user, such as images, videos, or movies (or music) that the user has seen or heard. In some implementations, identifying media content that a user has seen or heard may increase the likelihood that a particular written message is referencing the media content. For instance, if a user has started or has recently watched a video, the chances that the user will reference the video in a written message may increase. As another example, if the user has recently received a written message with a content pointer to a movie, and the user selects that content pointer to view the movie, the chances that the user will reference the video in a subsequent written message may increase significantly. As such, monitoring the viewing behaviors of a user may help enable content inference engine 240 to identify written messages that reference media content. Content inference engine 240 may use user viewing behavior as one factor to identify content that is being discussed

Media content metadata may include information associated with media content, such as a title (e.g., of an image or video), a date (e.g., a release date or a broadcast date), a time (e.g., 7:00 PM, primetime, late night, etc.), a director, a producer, an actor or model of the media content, a photographer, a genre, a theme, a content media type (e.g., image, music, video, etc.), etc. In some implementations, determining media content metadata may help enable content inference engine to identify written messages that reference media content since a written message may include a word or a phrase that corresponds to media content metadata. For example, a written message may include words and phrases such as “last night” and “zombies,” and content inference engine 240 may determine that a movie with zombies was broadcasted last night on a particular channel, and as such, the written message is likely referencing the zombie movie that was on last night. In some implementations, the broadcast (e.g., last night's zombie movie) may have been broadcast using a system or network other than the network used by user devices 210 to communicate with one another (e.g., a cable television network, a third-party content server, etc.).

Timing information may include timestamp information, or another type of timing information, relating to written messages. For example, timing information may include a timestamp of a written message that includes a content pointer relative to a timestamp of another written message. In some implementations, a written message may have an increased chance of referencing media content when the written message is sent immediately before or immediately after a written message that includes a content pointer or that is otherwise known to reference media content. In some implementations, timing information may also include media content that is not viewed by the user via user device 210. For instance, content inference engine may receive timing information relating to live events (such as the World Cup or the Super Bowl) that users may not view via user devices 210 but that may nevertheless be discussing via written messages. In such a scenario, users may refer to such events in written messages as “the game,” “the match,” etc., which may suggest to content inference engine 240 that the written messages may be referring to the live event.

User profile information may include information about the user of user device 210. Examples of user profile information may include demographic information (e.g., age, gender, etc.), media content preferences (e.g., media content that the user has enjoyed, genres that the user tends to enjoy, media content favorites as specified by the user, etc.), viewing history information, browsing habits of the user, user information available via social media services (e.g., Facebook, Tumblr, etc.) or other available platforms, etc. In some implementations, being aware of user profile information may better enable content inference engine 240 to identify written messages that reference media content. For instance, if two users are communicating with one another, and both users share demographic information, media content preferences, and viewing histories, the users may be more likely to discuss media content that they have seen or that they would likely be interested in seeing.

As shown, content pointers, user comments, user viewing behavior, media content metadata, timing information, and user profile information may be inputted into a content inference algorithm (which may be implemented by content inference engine 240). The content inference algorithm may be implemented in a variety of ways that may include a single algorithm or multiple algorithms. The content inference algorithm may identify written messages that reference media content, determine the media content referred to by such written messages, determine or infer whether the user viewed or listened to the media content, and determine the nature of the reference to the media content (e.g., did one user recommend the media content to another user, how much (or how little) did the user enjoy the media content, etc.). Additionally, the content inference algorithm may be implemented to provide several outputs, such as written message organization, user profile information, and media content reviews.

Written message organization may include causing user devices 210 to organize written messages displayed within a GUI of user devices 210 based on the message content of the written messages. For instance, content inference engine 240 may cause user devices 210 to organized written message by causing user devices 210 to insert titles within the GUI to indicate when a particular piece of media content is being discussed. FIG. 5, and the corresponding description, provides an example of organizing written messages based on message content.

Content inference engine 240 may also generate user profile information for a particular user based on written messages from a user and the other information represented in FIG. 4 (e.g., content pointers, user comments, user viewing behavior, etc.). For instance, when a written message indicates that a user appears to have enjoyed a particular movie (e.g., the user has a positive opinion of the movie), content inference engine 240 may create user profile information indicating a preference by the user for the movie (and/or movies that are similar). As another example, when a written message indicates that user appears to have not enjoyed a movie, content inference engine 240 may create user profile information indicating the user's lack of a preference for the movie (and/or movies that are similar). In some implementations, content inference engine 240 may communicate the user profile information to another network device, such as media content server 230, so that media content recommendations provided to the user may take into account whether or not (and/or how much) the user enjoyed a particular piece of media content.

Content inference engine 240 may create a user review based on written message from the user. In some implementations, a user review may include an actual quote copied from a written message from a user regarding media content. In some implementations, a user review may include a rating (e.g., thumbs up or thumbs down, a number of stars, a number of turkeys, etc.) that is indicative of the user's preference for the corresponding media content. In some implementations, a user review may include demographic information (or other types of user profile information) that may be used to identify whether another user might also enjoy the media content.

As described above, content pointers, user comments, user viewing behavior, media content metadata, timing information, and user profile information may be evaluated by content inference engine 240 as factors to determine the content of written messages (e.g., whether a written message includes, or references, media content, what the media content is, etc.). In some implementations, content inference engine 240 may use neural network, or another type of modeling technique, to evaluate the factors provided in FIG. 4 to determine whether a written message refers to media content and what the written message says about the media content. In some implementations, content inference engine 240 may implement a weighted analysis, a statistical analysis, and/or other types of analyses in evaluating the foregoing factors to determine the nature of a written message.

FIG. 5 is an example of written messages that have been organized with a GUI of user device 210. As shown, the GUI of user device 210 may include media content (such as an image or a movie that is displayed within a media content and messaging application installed on user device 210. The GUI may also include a series of comments (or written messages) that have been communicated between two or more users. Each written message may include text that was inputted by the user sending the written message and/or a hyperlink (or another type of selectable interface object) that the user receiving the message may select in order to view (or listen to) a particular piece of media content. In some implementations, a written message may include additional information, such as an identifier, a comment score, a date, etc. Examples of an identifier may include name, a user name, or a picture of the user from which the written message originated; examples of a comment score may include an indication of the value of the written message (e.g., a number of likes, a number of thumbs-ups, etc.); and the date may include the time and/or date that the written message was created. The written messages may be organized chronologically within the GUI.

Additionally, as described herein, content inference engine 240 may analyze the written messages to identify written messages that refer to media content. In doing so, content inference engine 240 may consider one or more types of information, such as content pointers, user comments, user viewing behavior, media content metadata, trimming information, user profile information, etc., which are discussed above with reference to FIG. 4. Additionally, content inference engine 240 may cause user devices 210 to organize the written comments within the GUI. For instance, as shown, content inference engine 240 may cause user device 210 to insert topic titles or headers within the GUI in order to indicate the topical flow of the discussion created by the written messages.

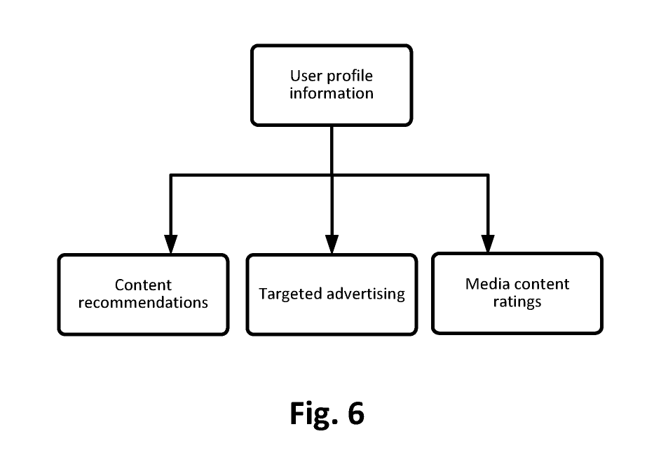

FIG. 6 is a logical flow diagram of an example for utilizing user profile information that is generated from written messages between users. In some implementations, the logical flow diagram of FIG. 6 may be implemented by content inference engine 240.

As shown, content inference engine 240 may use user profile information to provide media content recommendations, to provide targeted advertising, and/or create media content ratings. For instance, content inference engine 240 may infer media content preferences of a user based on written messages from the user and use the media content preferences to provide the user with enhanced recommendations of media content that the user would likely enjoy. In some implementations, content inference engine 240 may provide the content recommendations to the user directly (via user device 210). Alternatively, content inference engine 240 may provide the media content recommendations to the user by communicating media content preferences to media content server 220 that may, in turn, provide the media content recommendations to the user.

Additionally, content inference engine 240 may provide targeted advertising to the user based on the user profile information generated from written messages of a particular user. For instance, upon determining the media content preferences of a particular user (based on the written messages from the user), content inference engine 240 may cause advertisements associated with the media content preferences to be provided to the user (via user device 210). As an example, if content inference engine 240 determines that the user enjoyed the most recent Spiderman movie, content inference engine 240 may identify products and services associated with the Spiderman movie, and cause advertisements associated with the products and services to be provided to the user device 210 of the user. In some implementations, content inference engine 240 may provide the advertisements directly to user device 210. In some implementations, content inference engine 240 may cause the advertisements to be provided to user device 210 in another way, such as by communicating the media content preferences of the user to content media server 210, an advertisement server, or another network device.

Content inference engine 240 may also create content ratings based on the media content preferences of a user. For instance, upon determining the media content preferences of a particular user (based on the written messages from the user), content inference engine 240 may cause a media content rating (e.g., a number of stars, a number of thumbs-up, etc.) to be updated based on the media content preferences. In some implementations, the media content preferences of multiple users may be combined to provide an overall rating for a particular piece of media content. In generating media content ratings, content inference engine 240 may use a weighted approach, such as giving greater weight to more recent user preferences, to preferences from users that fall within a target demographic of the media content, etc. Additionally, the media content ratings may be organized in a variety of ways, such as having multiple ratings for each piece of media content, where each rating is specific to a particular demographic, a geographic location, etc. Accordingly, content inference engine 240 may use user profile information derived from written messages to automatically produce content recommendations, provide targeted advertising, and/or generate media content ratings.

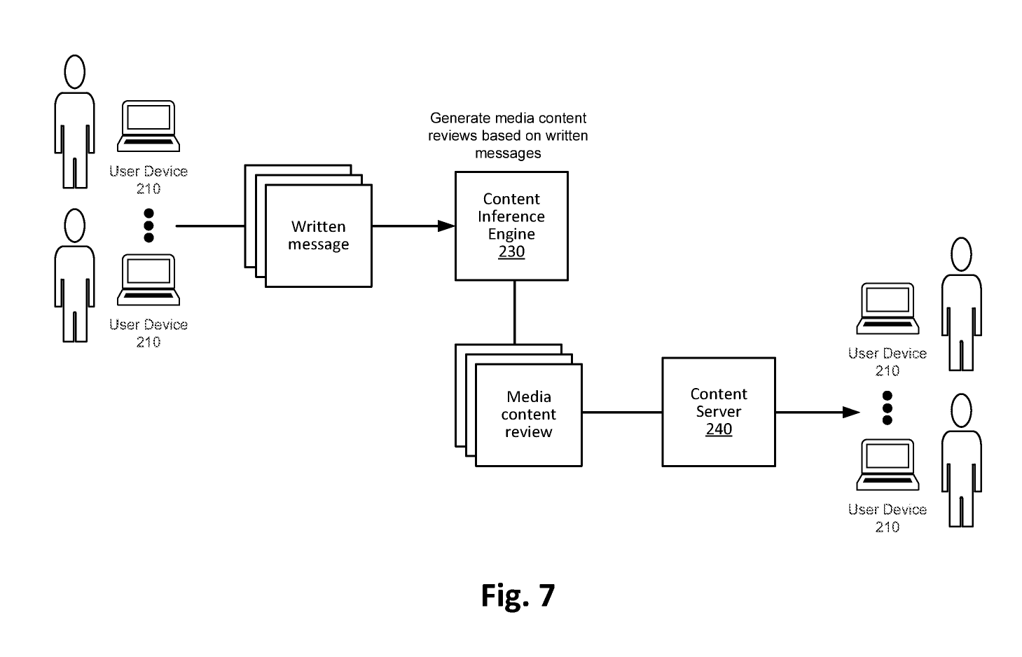

FIG. 7 is a diagram of an example for creating media content reviews based on written messages from users. As shown, content inference engine 230 may receive a copy of written messages that are communicated between user devices 210. The written messages may be part of a mobile messaging application, SMS messages, instant messages, or another types of written messages transmitted between user devices 210. Content inference engine 240 may generate media content reviews based on the written messages. The media content reviews may include words, quotes, or other information contained in the written messages. For example, the media content reviews may include a name or username of a user, a creation date, demographic information of the user corresponding to the media content review, an indicator of a positive or negative review (e.g., a number of stars, a thumbs up, a thumbs down, etc.), etc.

Content inference engine 230 may communicate the media content reviews to content server 240, and media content server may provide the media content reviews to other users that may be browsing for media content to view or listen to. The media content review may be provided to the users, along with pictures, a synopsis, clips, trailers, metadata, reviews of other users, an overall rating, etc., of the corresponding media content. In some implementations, the media content reviews may be combined with media content reviews from other users to create an overall rating for the corresponding piece of media. In some implementations, the media reviews may enable content server 240 to provide targeted content recommendations (e.g., media content recommendations directed to users that share demographic information or that have similar preferences as the user from which the media content review was created).

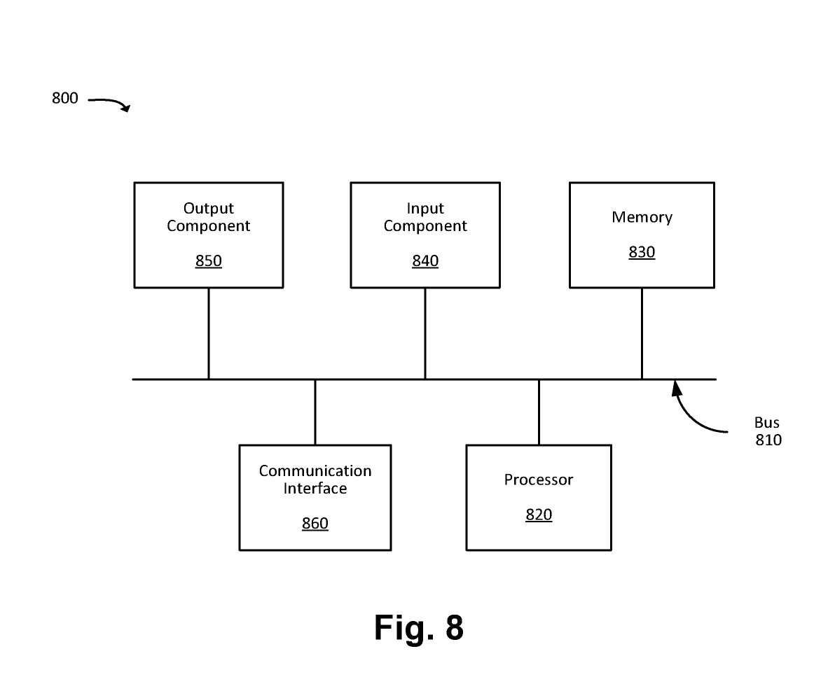

FIG. 8 is a diagram of example components of a device 800. Each of the devices illustrated in FIGS. 1, 2, 5, and 7 may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, or processing logic that may interpret and execute instructions. Memory 830 may include any type of dynamic storage device that may store information and instructions for execution by processor 820, and/or any type of non-volatile storage device that may store information for use by processor 820.

Input component 840 may include a mechanism that permits an operator to input information to device 800, such as a keyboard, a keypad, a button, a switch, etc. Output component 850 may include a mechanism that outputs information to the operator, such as a display, a speaker, one or more light emitting diodes (LEDs), etc.

Communication interface 860 may include any transceiver-like mechanism that enables device 800 to communicate with other devices and/or systems. For example, communication interface 860 may include an Ethernet interface, an optical interface, a coaxial interface, or the like. Communication interface 860 may include a wireless communication device, such as an infrared (IR) receiver, a cellular radio, a Bluetooth radio, or the like. The wireless communication device may be coupled to an external device, such as a remote control, a wireless keyboard, a mobile telephone, etc. In some embodiments, device 800 may include more than one communication interface 860. For instance, device 800 may include an optical interface and an Ethernet interface.

Device 800 may perform certain operations described above. Device 800 may perform these operations in response to processor 820 executing software instructions stored in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device. The software instructions stored in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of lines, arrows, and/or blocks have been described with regard to FIGS. 1, 3, 4, and 7 the order of the blocks and arrangement of the lines and/or arrows may be modified in other implementations. Further, non-dependent blocks may be performed in parallel. Similarly, while series of communications have been described with regard to several of the Figures provided herein, the order or nature of the communications may potentially be modified in other implementations.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. This logic may include hardware, such as an application-specific integrated circuit (ASIC) or a field-programmable gate array (FPGA), or a combination of hardware and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method performed by one or more network devices, comprising:
receiving, by the one or more network devices, copies of written messages communicated between user devices;
identifying, by the one or more network devices, a written message, of the copies of the written messages, that refers to media content;
identifying, by the one or more network devices, the media content to which the written message refers;
determining, by the one or more network devices, an opinion of a user, regarding the media content, based on content of the written message; and
creating, by the one or more network devices, user profile information based on the opinion of the user regarding the media content.

2. The method of claim 1, further comprising:
generating a recommendation for other media content based on the user profile information; and
communicating the recommendation to the user.

3. The method of claim 1, further comprising:
updating, based on the user profile information, a preexisting user profile of the user,
identifying an advertisement based on the updated user profile;
determining, based on the updated user profile information, at least one advertisement, from a plurality of advertisements, that is suitable for the user communicating the at least one advertisement to the user.

4. The method of claim 1, further comprising:
ascertaining a rating score for the media content based on the user profile information;
associating the rating score with the media content; and
providing the rating score, in association with the media content, to another user device.

5. The method of claim 4, wherein associating the rating score with the media content includes combining the rating score with a plurality of other rating scores, from other users, for the media content.

6. The method of claim 1, further comprising:
analyzing the content of the written messages to identify a change in a discussion topic between users;
generating a topic header to represent the change in the discussion topic;
providing the topic header to the user devices; and
providing instructions to the user devices to display the topic headers in the graphical user interfaces (GUIs) of the user devices in order to visually represent the change in the discussion topic between the user devices.

7. The method of claim 1, further comprising:
generating a review of the media content based on the opinion of the user regarding the media content; and
associating the review with the media content; and
providing the review, in association with the media content, to another user device for consideration by another user.

8. The method of claim 1, wherein the written messages include at least on of:
short message Service (SMS) messages,
instant messaging (IM) messages;
electronic mail messages, or
posts on a discussion board of a webpage.

9. One or more network devices, comprising:
a non-transitory memory device storing a plurality of processor-executable instructions; and
a processor configured to execute the processor-executable instructions, wherein executing the processor-executable instructions causes the processor to:
receive copies of written messages communicated between user devices;
identify a written message, of the copies of the written messages, that refers to media content;
identify the media content to which the written message refers;
determine a opinion of a user, regarding the media content, based on text inputted into the written message by the user; and
create user profile information based on the opinion of the user regarding the media content.

10. The one or more network devices of claim 9, wherein executing the processor-executable instructions causes the processor to:
generate a recommendation for other media content based on the user profile information; and
communicate the recommendation to the user.

11. The one or more network devices of claim 9, wherein executing the processor-executable instructions causes the processor to:
update, based on the user profile information, a preexisting user profile of the user,
identify an advertisement based on the updated user profile;
determine, based on the updated user profile information, at least one advertisement, from a plurality of advertisements, that is suitable for the user
communicate the at least one advertisement to the user.

12. The one or more network devices of claim 9, wherein executing the processor-executable instructions cause the processor to:
ascertain a rating score for the media content based on the user profile information;
associate the rating score with the media content; and
provide the rating score, in association with the media content, to another user device.

13. The one or more network devices of claim 12, wherein to associate the rating score with the media content, the processor-executable instructions causes the processor to:
combine the rating score with a plurality of other rating scores, from other users, for the media content.

14. The one or more network devices of claim 9, wherein executing the processor-executable instructions cause the processor to:
analyze the content of the written messages to identify a change in a discussion topic between the users;
generate a topic header to represent the change in the discussion topic;
provide the topic header to the user devices; and
provide instructions to the user devices to display the topic headers in the graphical user interfaces (GUIs) of the user devices in order to visually represent the change in the discussion topic between the user devices.

15. The one or more network devices of claim 9, wherein executing the processor-executable instructions cause the processor to:
generate a review of the media content based on the opinion of the user regarding the media content; and
associate the review with the media content; and
provide the review, in association with the media content, to another user device for consideration by another user.

16. The one or more network devices of claim 9, wherein the written messages include at least on of:
short message Service (SMS) messages,
instant messaging (IM) messages;
electronic mail messages, or
posts on a discussion board of a webpage.

17. One or more network devices, comprising:
a non-transitory memory device storing a plurality of processor-executable instructions; and
a processor configured to execute the processor-executable instructions, wherein executing the processor-executable instructions causes the processor to:
receive copies of messages corresponding to a discussion between users via user devices,
analyze the content of the messages to identify a change in a discussion topic between the users;
generate a topic header to represent the change in the discussion topic;
provide the topic header to the user devices; and
provide instructions to the user devices to display the topic headers in the graphical user interfaces (GUIs) of the user devices in order to visually represent the change in the discussion topic between the users.

18. The one or more network devices of claim 17, wherein executing the processor-executable instructions cause the processor to:
identify written messages, of the copies of written messages, that relate to media content being discussed by the users,
identify the media content referred to in the written messages,
determine, based on the discussion in the written messages, opinions of the users, regarding the media content.

19. The one or more network devices of claim 17, wherein executing the processor-executable instructions cause the processor to:
create user profile information based on the opinions of the users regarding the media content; and
update user profiles of the users based on the user profile information.

20. The one or more network devices of claim 19, wherein the updated user profiles are used to:
automatically provide media content recommendations for the users,
automatically provide targeted advertisements to the users,
automatically generate a rating score for the media content, or
automatically generate user reviews for the media content.
